(19) United States
(12) Patent Application Publication
(10) Pub. No.: US 2012/0178060 A1
(43) Pub. Date: Jul. 12, 2012

(54) PERSONALIZED ANIMATED STORYBOOK AND RELATED METHODS

(76) Inventor: Andrew Gitt, St. Louis, MO (US)

(21) Appl. No.: 13/215,891

(22) Filed: Aug. 23, 2011

Related U.S. Application Data
(60) Provisional application No. 61/376,553, filed on Aug. 24, 2010.

(51) Int. Cl. G09B 17/00

(52) U.S. Cl. 434/178

(57) ABSTRACT

An animated, personalized storybook. This storybook utilizes pictures of a child or other subject which are provided by the purchaser of the storybook to provide for a personalized experience in the storybook. As the storybook is electronic, not only can the storybook provide for personalized images, it can animate those images to provide for a more interactive reading experience. Specifically, in an embodiment, not only are the stock or other characters animated, but the child themselves appears in an animated fashion and they can be shown directly interacting with the other action in the story allowing for a very personalized and immersive reading experience.

### CROSS REFERENCE TO RELATED APPLICATION(S)

This application claims the benefit of and priority to U.S. Provisional Patent Application Ser. No. 61/376,553, filed Aug. 24, 2010, the entire disclosure of which is herein incorporated by reference.

### BACKGROUND OF THE INVENTION

1. Field of the Invention

This invention relates to personalized storybooks that can be used to teach children reading ability, as well as to provide for social awareness campaigns and personalized promotion for a book creator.

2. Description of the Related Art

Today's kids are much more likely to be found in front of a television screen watching an animated cartoon or in front of a computer watching a video or playing a video game than they are to be reading. At the same time, child development experts will generally agree that reading to a child in infancy and the early years, and a child's reading to themselves once they are able, are some of the most important developmental tools that can be used to achieve improved literacy and language use mastery.

The problem with many traditional reading mediums, however, is that they lack the attention grabbing ability of a moving screen image. While books are generally passive requiring the user to engage them, television and audio/visual presentations are often designed to grab and hold attention. Further, while there have been attempts made to utilize the video media to provide learning, they often fall short of their goal as it has been recognized that the video medium is often not sufficient to provide for valuable learning, particularly at a very young age.

Further, while audio/visual presentations are generally designed to make the viewer part of the action, a trend which has increased even more in recent years, books and reading material often require a greater imaginative response to make the user part of the action.

While some forms of interactive books, where children will read along with a voice or video that simultaneously reads the material, these systems are generally not personalized to the child and are simply intended to replicate the act of a parent reading. Similarly, there are personalized animated systems that can be used to star a child, but these systems generally require that only the child's head or face be used in the personalization, which often looks retrofitted and “fake” when compared to the remainder of the animation. Further, these systems are generally not designed to provide for interactive reading, and do not provide the ability to be customized by a book promoter to provide for socially conscious awareness, advertising, and branding.

### SUMMARY OF THE INVENTION

The following is a summary of the invention, which should provide to the reader a basic understanding of some aspects of the invention. This summary is not intended to identify critical elements of the invention or in any way to delineate the scope of the invention. The sole purpose of this summary is to present in simplified text some aspects of the invention as a prelude to the more detailed description presented below.

Because of these and other problems in the art, described herein, among other things, is an animated, personalized storybook. This storybook utilizes pictures of a child or other subject which are provided by the purchaser of the storybook to provide for a personalized experience in the storybook. As the storybook is electronic, not only can the storybook provide for personalized images, it can animate those images to provide for a more interactive reading experience. Specifically, in an embodiment, not only are the stock or other characters animated, but the child themselves appears in an animated fashion and they can be shown directly interacting with the other action in the story allowing for a very personalized and immersive reading experience.

Described herein, among other things, is an interactive electronic storybook comprising: a display, the display displaying an animated image to a reader; a series of animated pages for display on the display, the animated pages comprising: a full body photographic image of a human being, the human being acting as the reader of the pages wherein the image is animated so that at least one of their arms, legs, or head can move on each page; a non-reader character being presented on at least some of the pages, the non-reader character being generated from a combination of photographs and drawn artwork; and a background, the background including a non-character image which includes a photographic image corresponding to the background of the story.

In an embodiment of the storybook, said animated pages are stored as computer readable code on a computer readable memory and said display comprises a computing device.

In an embodiment of the storybook, said full body photographic image of a human being comprises an image of a child.

In an embodiment of the storybook, said non-reader character comprises an anthropomorphized animal.

In an embodiment of the storybook, said photographic image in said non-character image includes a trademark logo.

In an embodiment of the storybook, said photographic image in said non-character image includes a branded image.

In an embodiment of the storybook, said photographic image in said non-character image indicates a specific business entity, such as, but not limited to, a professional sports team.

In an embodiment of the storybook, said photographic image in said non-character image is of a landmark which may be in a city in which the story takes place.

There is also described herein an interactive electronic storybook comprising: a computer, the computer including a display; a computer memory, the memory having thereon: computer readable instructions for displaying a series of animated pages for display on the display, the animated pages comprising: text; a full body photographic image of a human being; a non-reader character being presented on at least some of the pages, the non-reader character being generated from a combination of photographs and drawn artwork; and a background, the background including a non-character image which includes a photographic image corresponding to the background of the story; computer readable instructions for animating at least a portion of the body of the photographic image of a human being; and computer readable instructions for coordinating the animation of said at least a portion of the body of the photographic image to motion discussed in the text.

In an embodiment of the storybook, said at least a portion of the body comprises the head, arms, or legs.

There is also described herein a method for providing for interactive reading, the method comprising: photographing a human reader to obtain a full body photographic image of the human reader; providing a computer, the computer including a display; providing a computer memory, the memory having thereon: computer readable instructions for displaying a series of animated pages for display on the display, the animated pages comprising: text; the full body photographic image of the human reader; a non-reader character being presented on at least some of the pages, the non-reader character being generated from a combination of photographs and drawn artwork; and a background, the background including a non-character image which includes a photographic image corresponding to the background of the story; computer readable instructions for animating at least a portion of the body of the photographic image of the human reader; and computer readable instructions for coordinating the animation of said at least a portion of the body of the photographic image to motion discussed in the text; the computer displaying each of said animated pages in order and simultaneously, providing audio of the text, highlighting each word in the text as the audio plays that word, and animating the photographic image of the human reader.

In an embodiment of the method, said full body photographic image of a human being comprises an image of a child.

In an embodiment of the method, said non-reader character comprises an anthropomorphized animal.

In an embodiment of the method, said photographic image in said non-character image includes a trademark logo.

In an embodiment of the method, said photographic image in said non-character image includes a branded image.

In an embodiment of the method, said photographic image in said non-character image indicates a specific business entity, such as, but not limited to, a professional sports team.

In an embodiment of the method, said photographic image in said non-character image is of a landmark which may be in a city in which the story takes place.

### BRIEF DESCRIPTION OF THE DRAWINGS

FIGS. 1-16 provide screen shots of various embodiments of pages from an animated storybook display as would appear on a computer.

### DETAILED DESCRIPTION OF THE PREFERRED EMBODIMENT(S)

Although the present invention will be described hereinafter with particular reference to the accompanying drawings, it is to be understood at the outset that it is contemplated that the present invention may be varied in specific detail from that illustrated and described herein while still achieving the desirable characteristics and features of the present invention. Accordingly, the description that follows is intended to be understood as a broad enabling disclosure directed to persons skilled in the applicable arts, and is not to be understood as being restrictive.

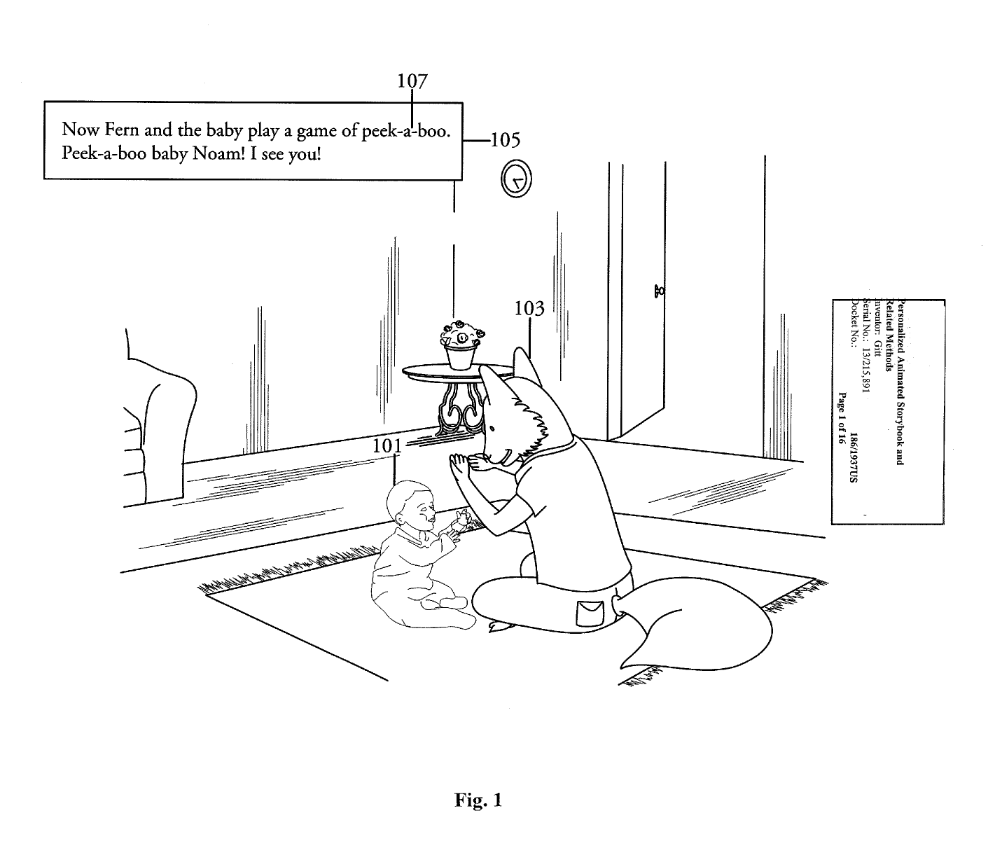

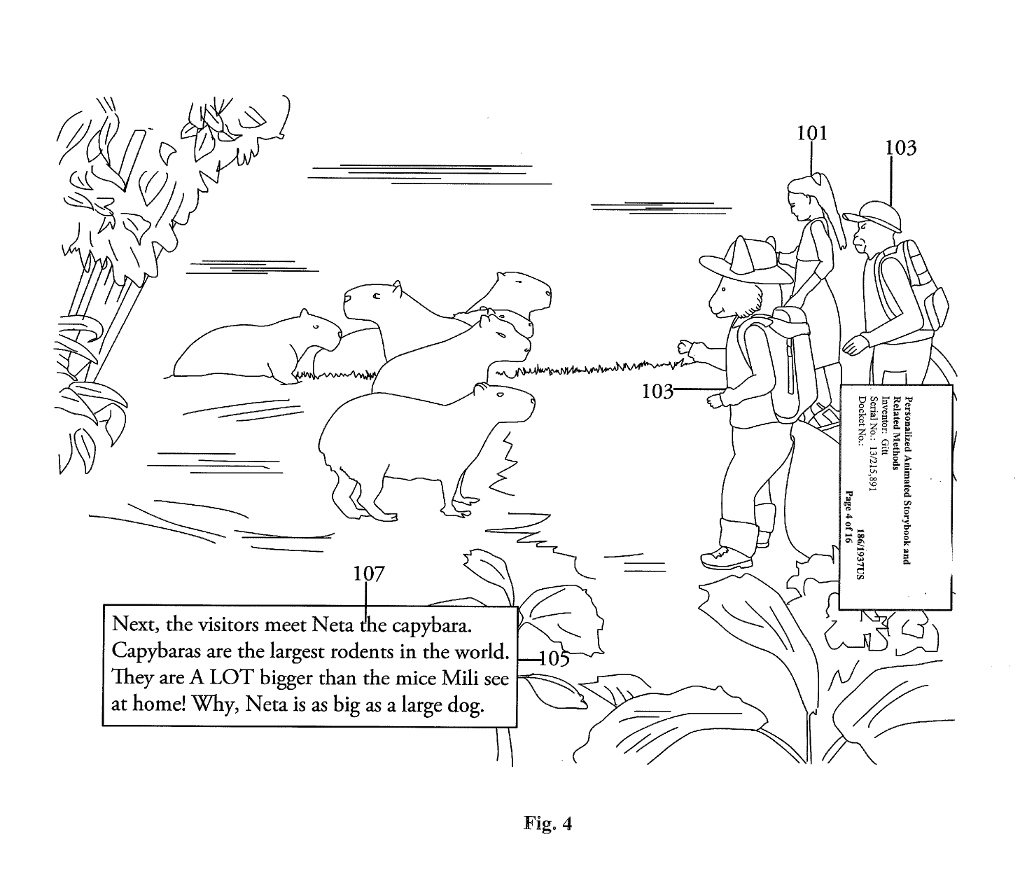

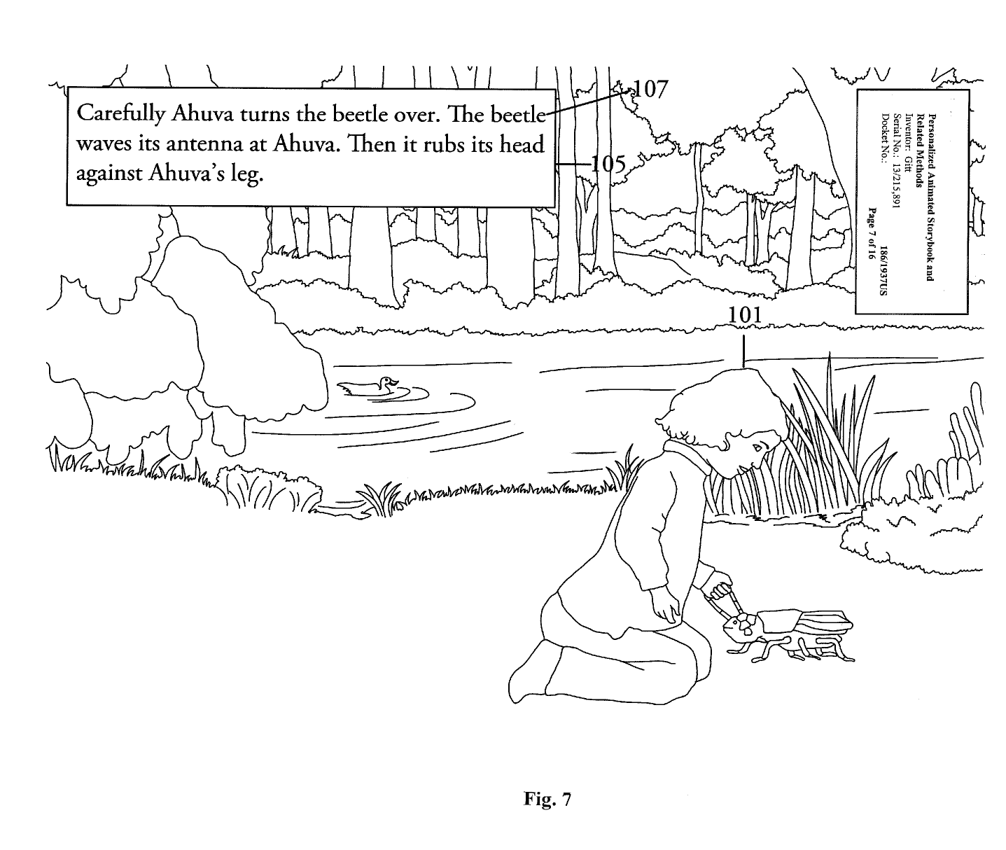

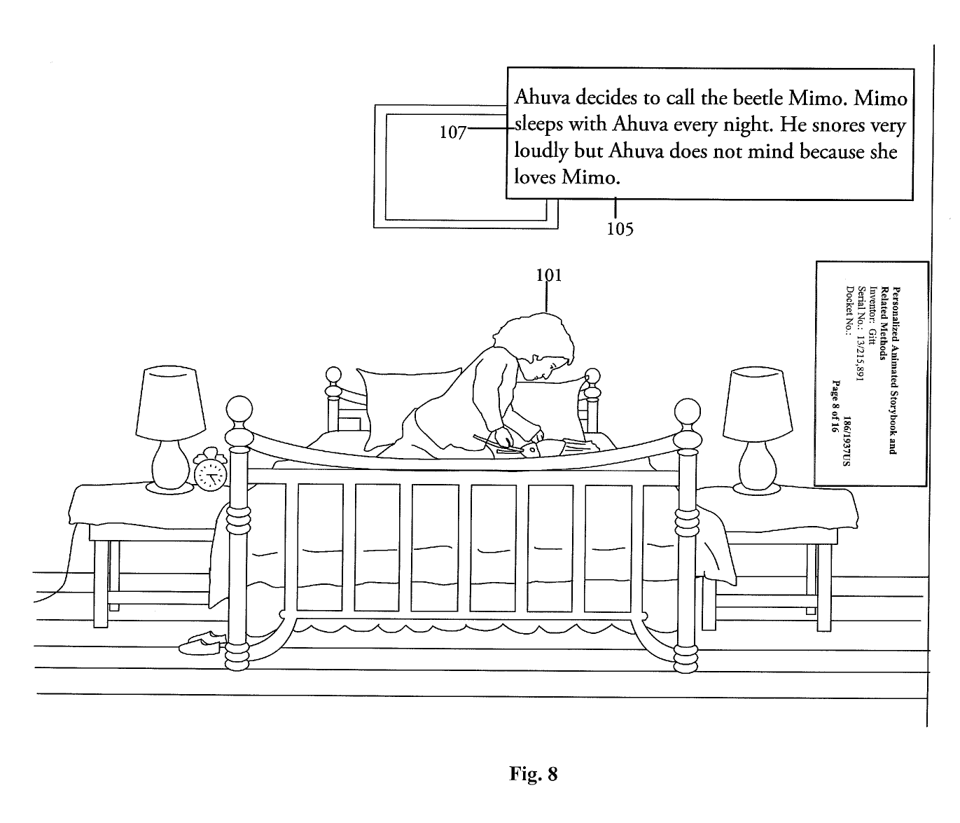

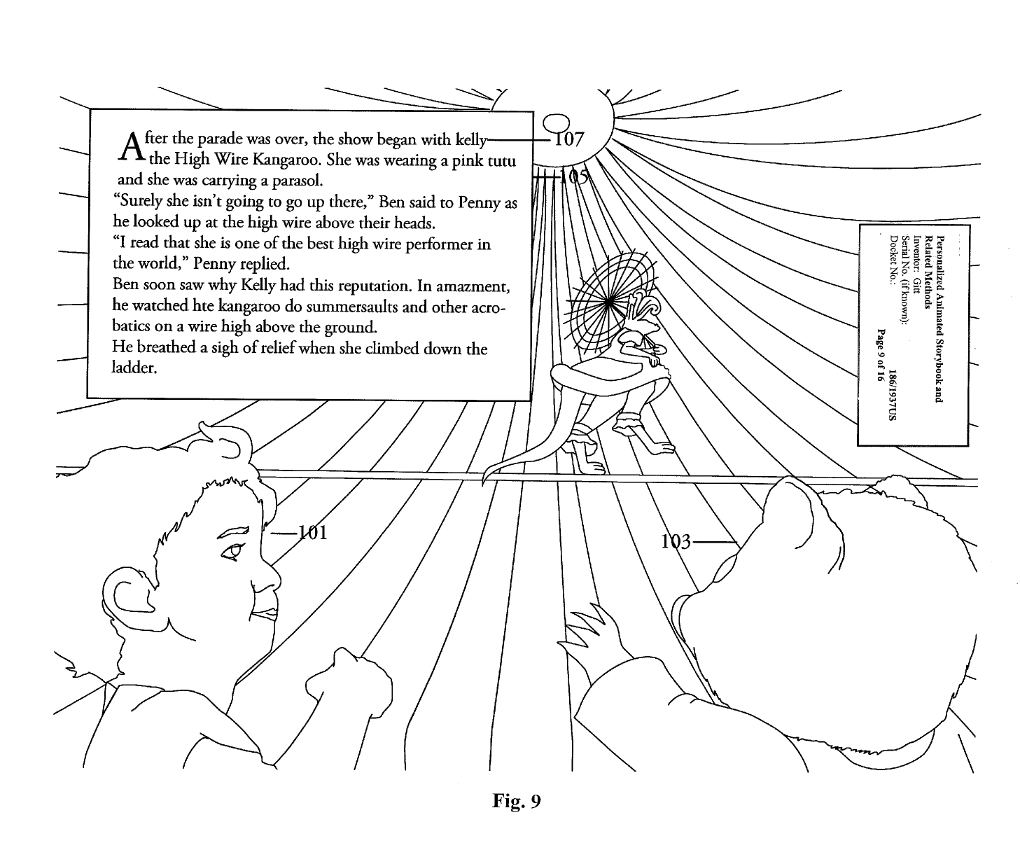

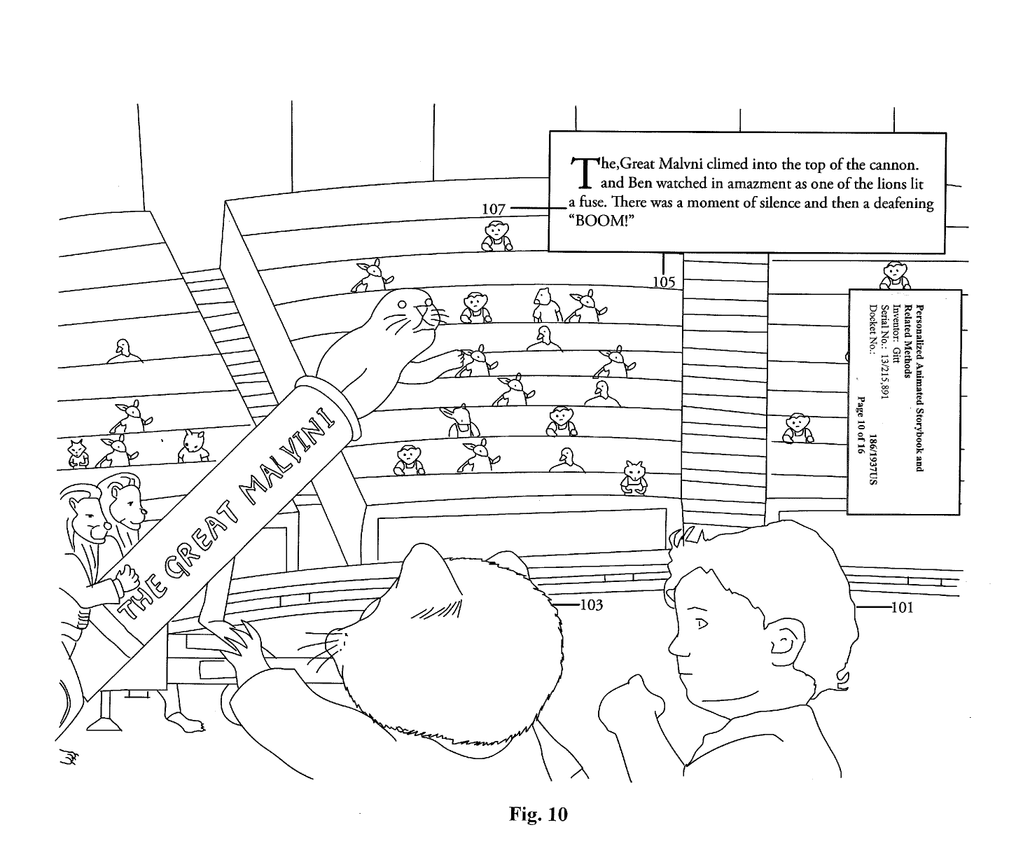

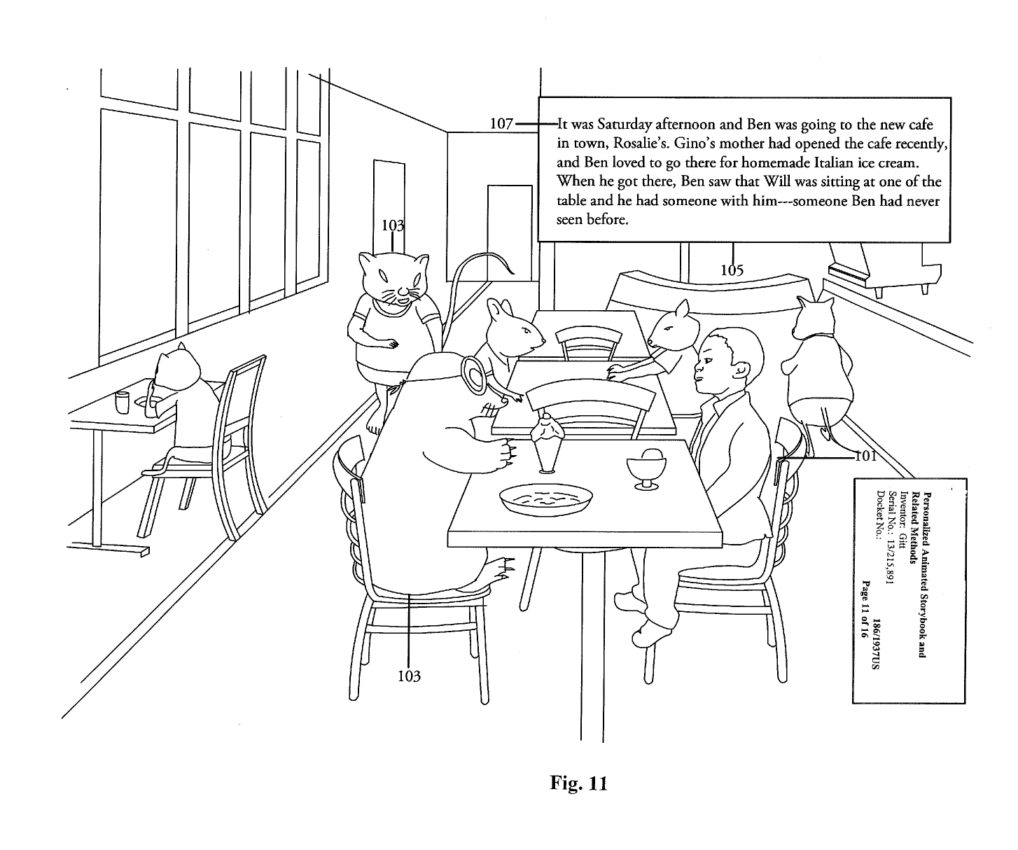

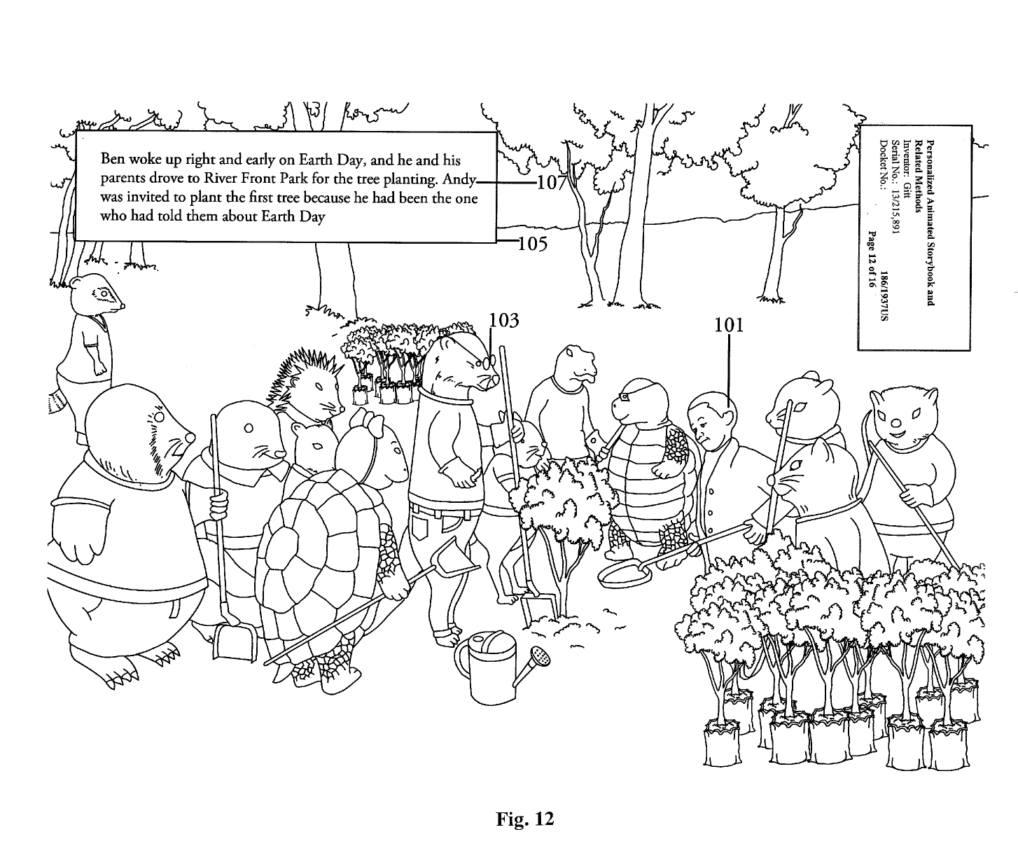

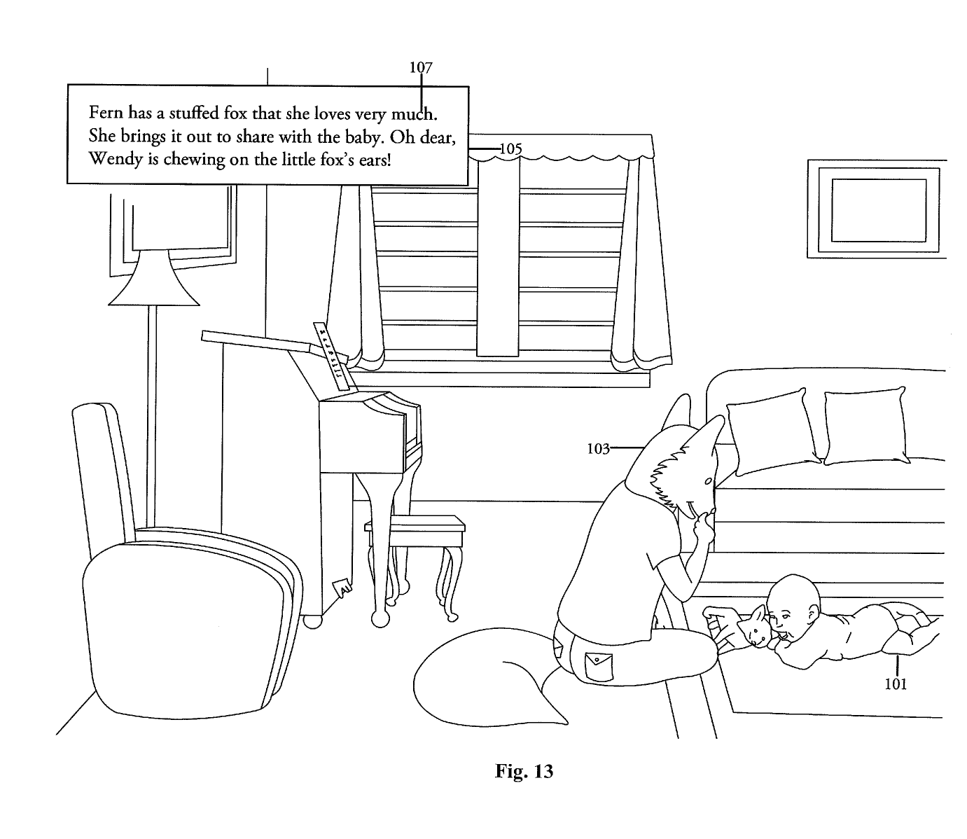

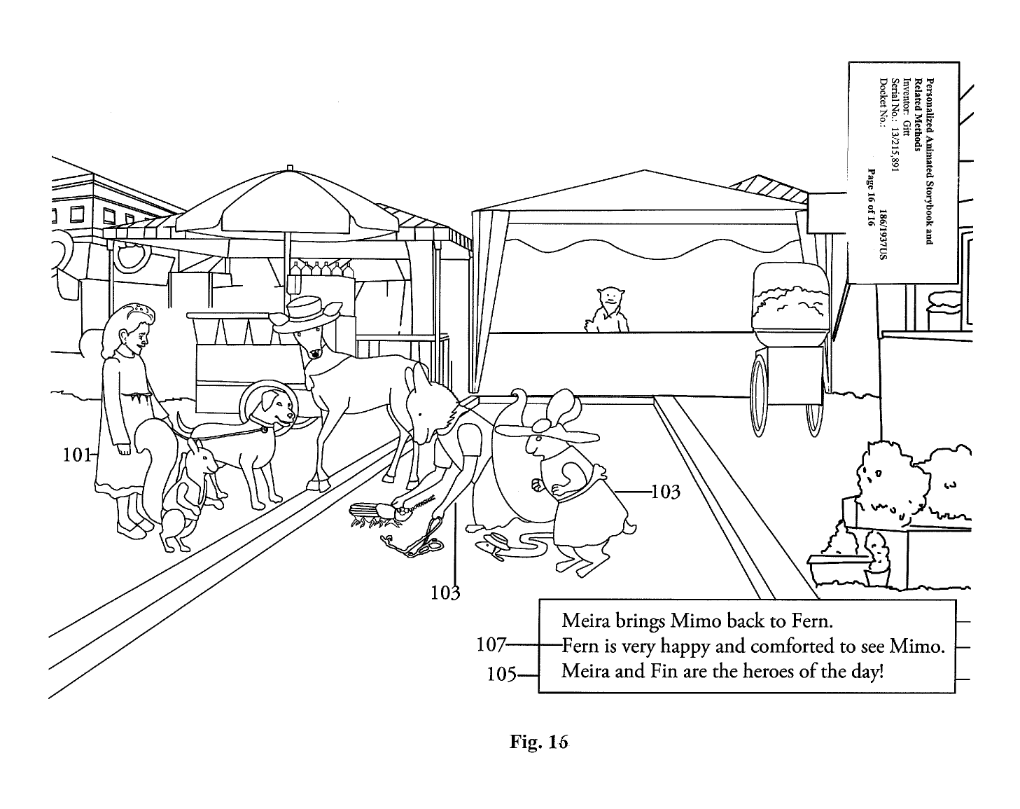

FIGS. 1-16 provide for various embodiments of screenshots showing “pages” from an animated electronic storybook. These pages are not from a single book but show a collection of pages from a number of possible books to illustrate elements of operation. It should be noted that the term “pages” is a bit of a misnomer as each page would animate and can be thought of as actually being a number of different “pages” or images in a traditional sense. The storybook can be provided in any number of electronic forms including, but not limited to, via a network (such as the Internet), as part of a computer readable memory (such as a hard, disk, floppy disk, non-volatile memory device) along with instructions for displaying it, or in any combination to any number of reader devices including, but not limited to, a computer, an e-book reader, a Smartphone, or a Personal Digital Assistant (PDA).

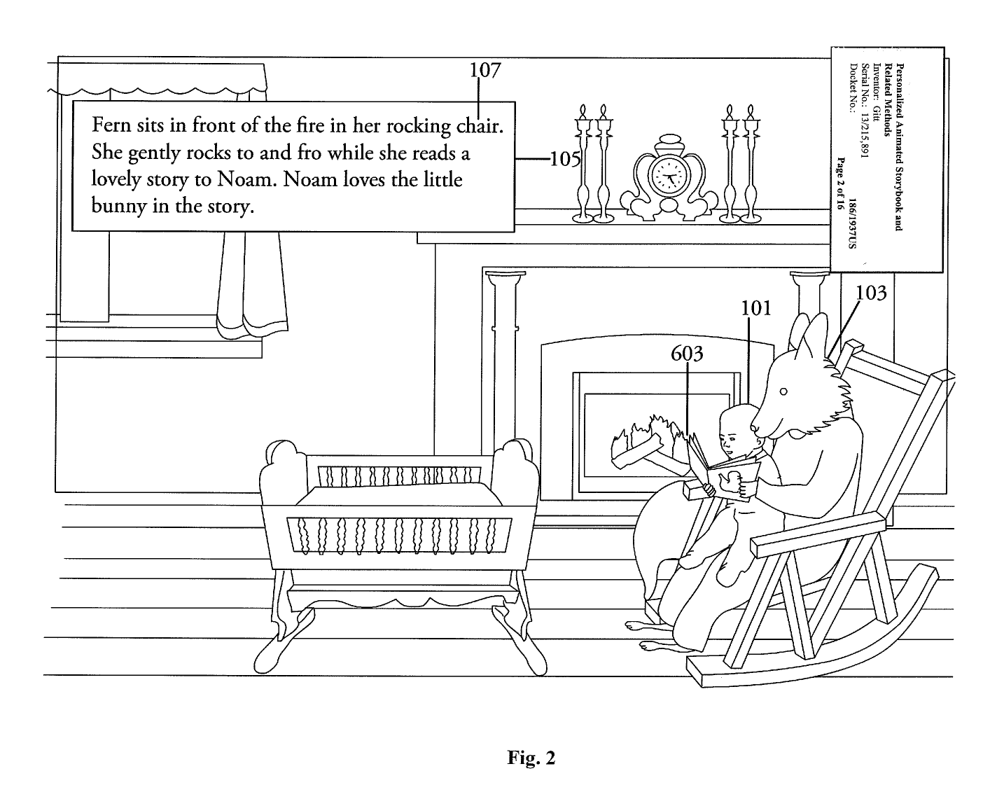

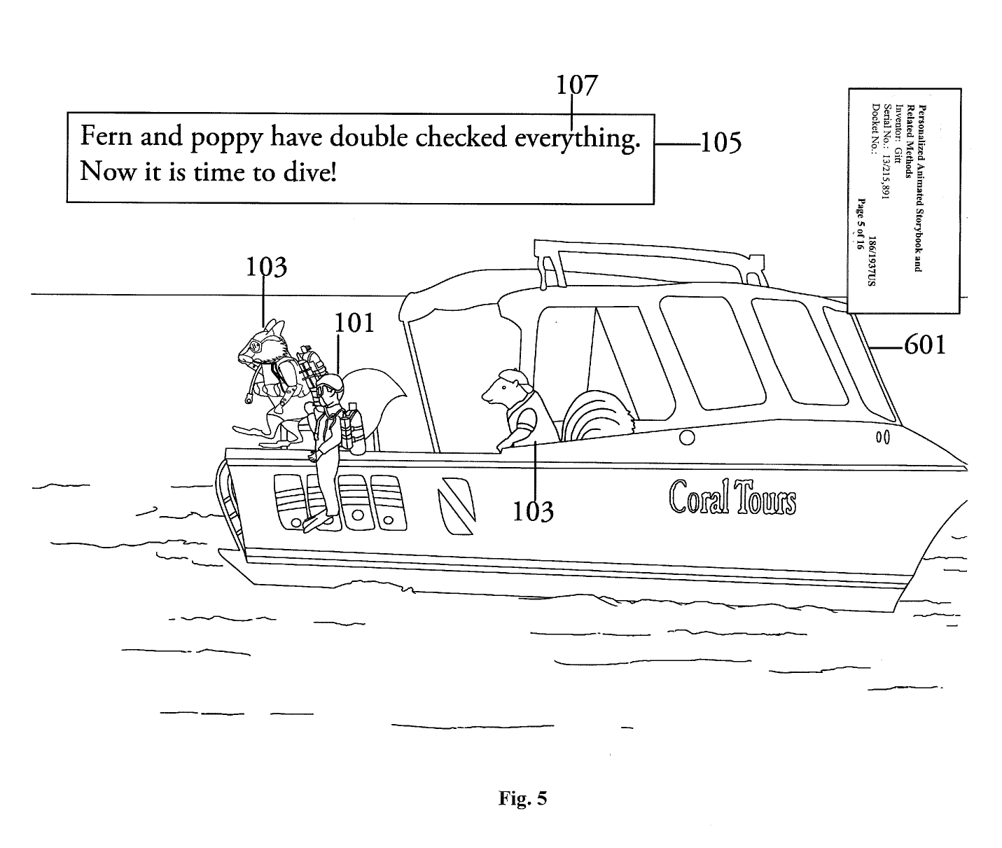

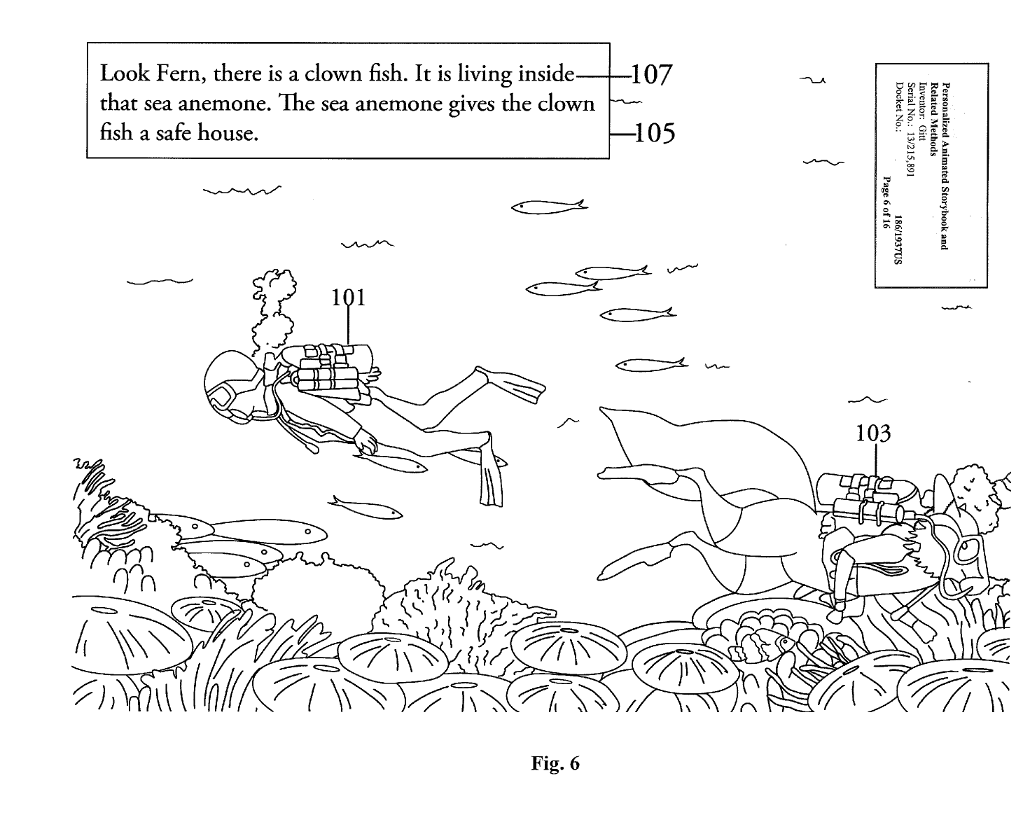

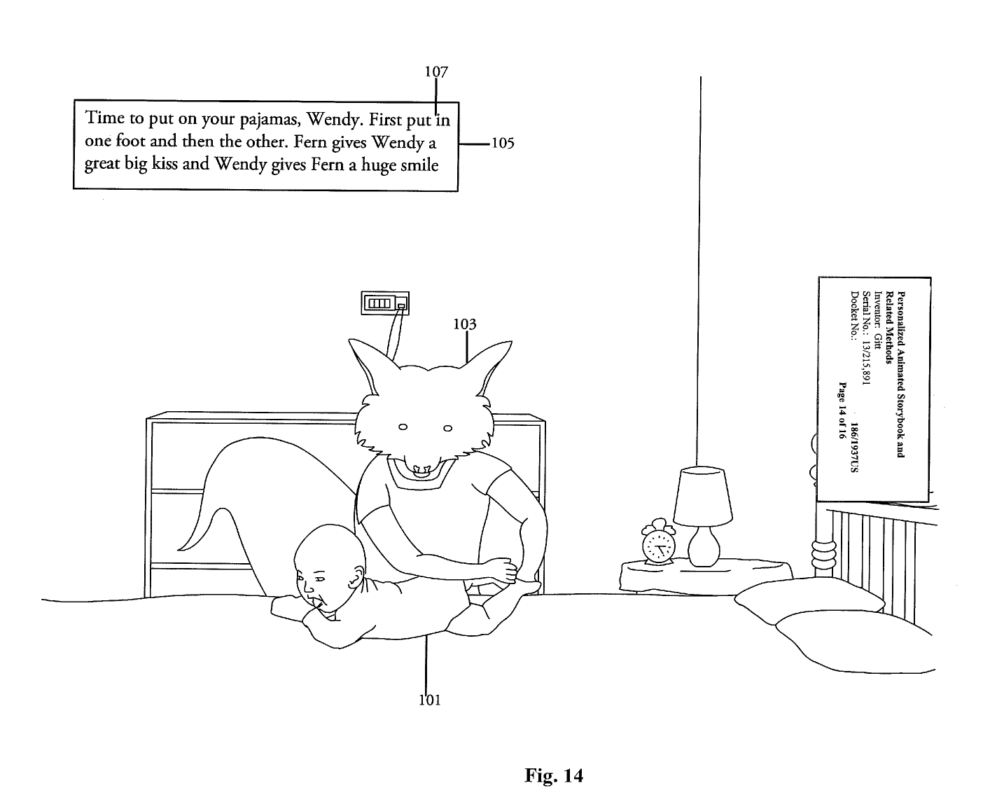

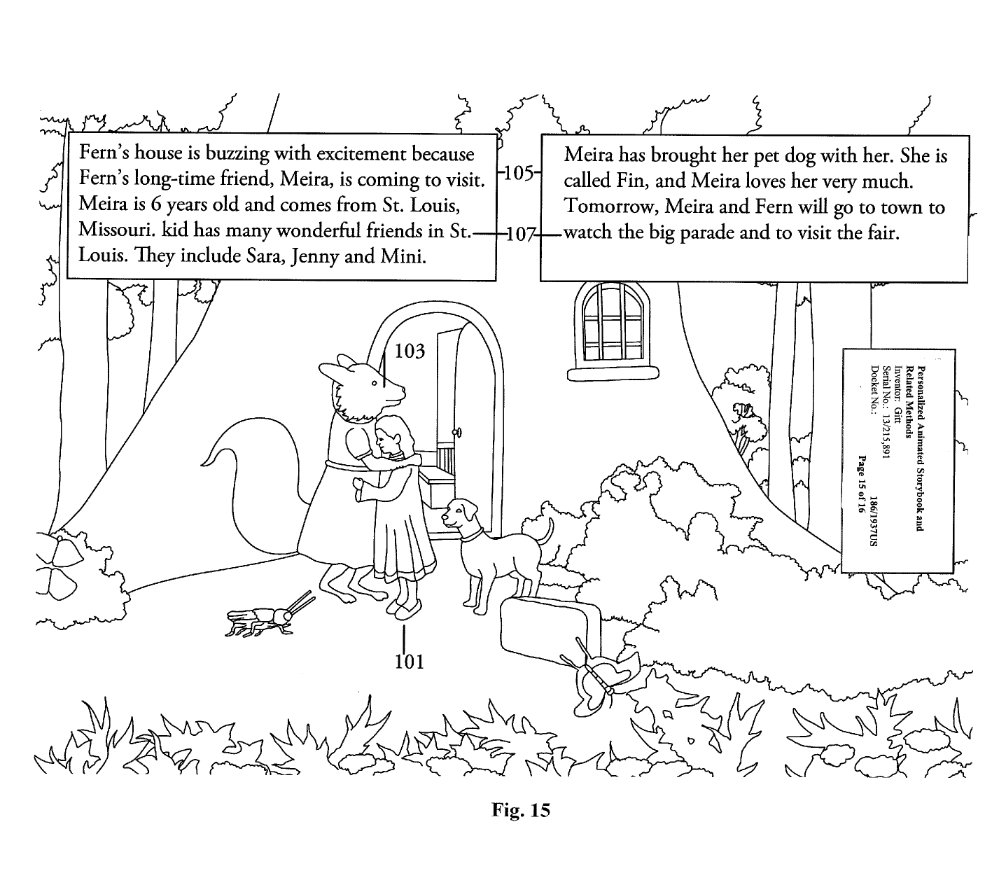

The pages may provide for a number of features depending on the embodiment. As shown in FIG. 1 there are provided the animation of the child or other individual that is the subject (101) of the story. In the depicted embodiment, the subject (101), which will generally be a child or other targeted reader, is animated and will move their arms, legs, head or other body parts to allow them to interact with the story. For example, in FIG. 2, the subject can be shown holding the book (603) being read to them (which may involve movement of the hands or head) and in FIGS. 5 and 6 the subject (101) can be shown diving form a boat (601) and swimming (which will involve movement of the arms, legs, and possibly head). FIG. 14 shows the subject (101) being dressed by another character (103) and FIG. 15 shows the subject (101) hugging one of the other characters (103). There are also provided additional animated characters (103) that can interact with the subject (101) such as, but not limited to, as indicated above.

In the depicted embodiment, it will generally be the case that the child is placed into the story in a whole body form. That is, their head is not transposed onto an animated characters body, but the entire body of the child is placed into the screen image and is animated. This provides for a couple of benefits over traditional interactive presentations. In the first instance, it personalizes the child not just with their face but with their favorite clothing and other elements of their appearance. This further enhances the fact that the image is them. A disembodied head on an animated body often looks artificial and results in the child not necessarily associating the depicted character as themselves, but instead as being a picture.

Including the entire child also allows the interactions of the child in the image to appear more natural. A moving arm (such as for a wave) has consist clothing to the child and the movements of the child (such as for walking) can be made to appear as the child walking instead of a head being superimposed on a different walking body. Further, including the entire child allows for better graphics universality. While there are systems which are designed to scale a head to an animated image, they often have the problem that the head has to be distended to be a particular shape and usually result in a situation where the head has dramatically more detail (or different types of detail) than the body does.

This change in detail can be particularly dramatic when the child is placed in a world with other characters that have animated faces. The child's body is at a level of detail that matches the other characters faces, but as their face is a photo, has a dramatically more detailed face. This conflicts with the other characters and their body. This can present problems as the character made with the child's face does not look “correct.” When the child is presented “whole,” while the child may look to be “visiting” the book universe because of the different level of detail, they do not appear to have been altered in a way that can result in the child looking “unreal”.

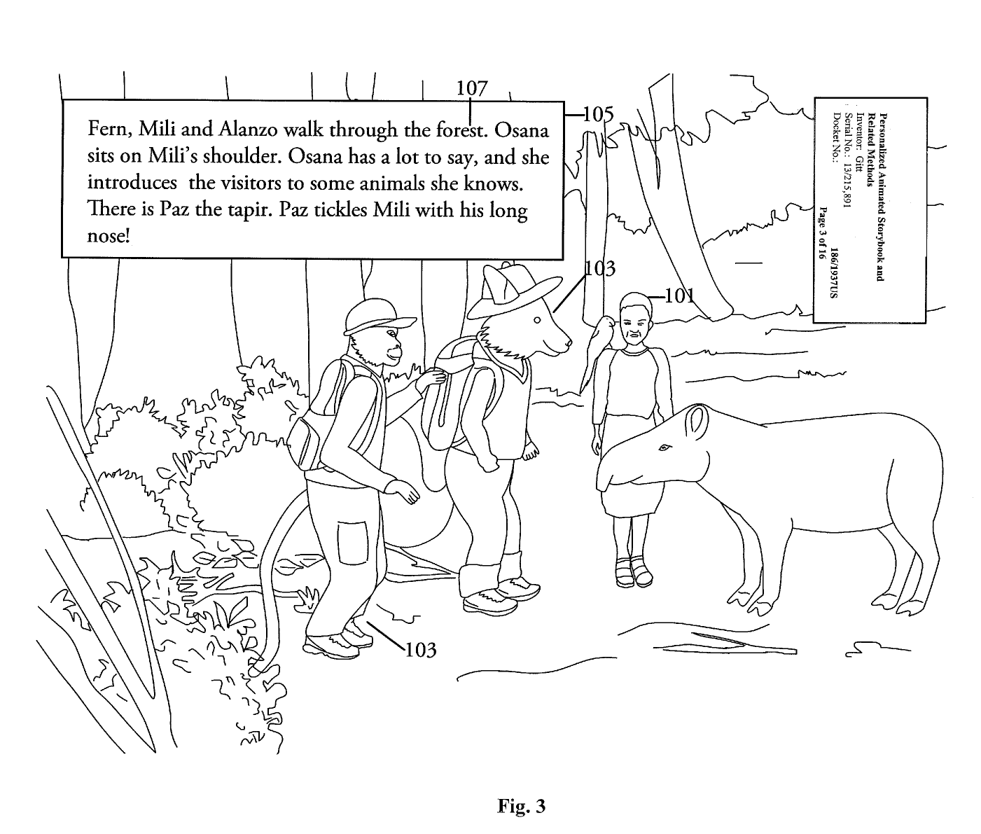

Further, in facial replacement systems, the individual is often forced to be facing the same direction on multiple pages. In the present system, a number of different photos can be used of the same child which can then allow for the child to be presented face on, in profile, or in specific poses depending on the requirements of the story. Further, the child can be presented with additional material (such as the scuba gear of FIGS. 5 and 6) which further tie the child to the universe. This effect can be further enhanced through the inclusion of other photo-based characters in the story. For example, in FIG. 3, the fox character is clearly created entirely by animation, while the child is entirely photo based. The remaining two characters (the anthropomorphized monkey and the tapir) comprises mixes of animation and photos which helps to tie the image together as a more coherent scene.

Each animated screen will generally also include a text block (105). This text may be read by the user of the storybook, or may be read “to them” via an associated audio track or both. In an embodiment, the soundtrack may also include sound effects or other sounds that provide for a more immersive experience. To enhance the effect of the story being read, different voices may be used for different characters and the text (107) may be highlighted or otherwise identified as the associated words are spoken.

While the storybook has the ability to provide, in an embodiment, for an educational and entertaining presentation on its own and can assist with reading ability simply by what it is, in another embodiment, the storybook can also be used to provide for social consciousness or other learning benefit. For example, the story can be about certain socially responsible topics, for example conservation, recycling, civic responsibility, or a myriad of other subjects providing for the storybook providing education outside of the pure literary realm. Similarly, the storybook can teach math, science or other educational concepts. The storybook can also or alternatively provide for more specific corporate, economic, or trade interests. For example, the storybook can encourage the purchase of insurance, the use of certain products, enhanced dental care, or shopping at certain stores.

As the storybook is interactive, in an embodiment the storybook need not only include personalized content for the subject (101), but may also include personalized background content or other marketing material. For example a store may appear as a specifically branded store instead of a generic one, or a specific product may appear and be used or interacted with. This branding content need not be commercial and charities may be shown in a branded fashion.

The branding ability is particularly powerful in the type of storybook illustrated as the storybook (as previously discussed) may utilize elements of photo in conjunction with animation to provide for a more coherent and interactive scene.

The branding may be through community organizations, trade groups, or city or other governmental organizations. Thus, for example, Major League Baseball could put together a storybook which utilizes references to specific teams and the city of Los Angeles could put together a storybook which would make specific reference to elements of the city. Essentially, the book can serve to be personalized both in its connection to the subject child, but also to the background and remaining characters provided.

As should be apparent from the above, the ability to personalize the storybook at a number of different levels provides for a number of different possibilities when it comes to marketing the book, such methods being included herein. The most apparent is that once a subject (101) has received or purchased a book, the animation created for them for that book could be transported into another. Still further, the first book may be provided by an organization promoting certain interests or activities. For example, a specific group, for example the American Bar Association (ABA) could get a book made that promotes certain justice related causes (for example pro bono legal services) or educates about the legal system. This book could include logos of the ABA as the sponsor of the book and the ABA could give the book away, allowing it to be personalized by each user for their child. In addition to promoting a cause as indicated but the content of the electronic storybook, the giveaway of such a storybook can also be used to promote literacy generally, another potentially desirable social cause.

The types of such additional education are nearly limitless and the books can be used to promote a wide variety of socially conscious business and lifestyle choices in addition to promoting a particular business or entity that is interested in being associated with that cause. In an example, a city (e.g. the city of Saint Louis) could provide the book as a free giveaway to promote tourism. The book can provide for images based on specific imagery for the city (for example the Arch, the Cardinals baseball team, and the Mississippi River) and can then be personalized to provide for a keepsake or promotion item related to a trip to the city.

The personalization is particularly powerful where the book is not only personalized to the reader, but the internal businesses or entities can also be personalized without changing any further material in the book. For example, the book can be arranged to provide for reference to a baseball team, and then the child's local (or favorite) baseball team can be used. Similarly, a book about recycling can utilize the local recycling companies name, and an image of their truck and even a driver, to make the book further specific to the reader.

In order to provide for revenue streams related to giveaways, and even future sales, of personalized books, there is also provided the ability to provide for reciprocal “commissions” form a sale of different books. Thus, in an embodiment, the ABA could give away a book as contemplated above, but if an individual who had not previously obtained an electronic storybook obtained the free book above, and then later purchased an additional book, the ABA may be provided a commission for being a referral source for that customer.

While the inventions have been disclosed in connection with certain preferred embodiments, this should not be taken as a limitation to all of the provided details of any invention. Modifications and variations of the described embodiments may be made without departing from the spirit and scope of any invention herein disclosed, and other embodiments should be understood to be encompassed in the present disclosure as would be understood by those of ordinary skill in the art.

1. An interactive electronic storybook comprising:
a display, the display displaying an animated image to a reader;
a series of animated pages for display on the display, the animated pages comprising:
a full body photographic image of a human being, the human being acting as the reader of the pages wherein the image is animated so that at least one of their arms, legs, or head can move on each page;
a non-reader character being presented on at least some of the pages, the non-reader character being generated from a combination of photographs and drawn artwork; and
a background, the background including a non-character image which includes a photographic image corresponding to the background of the story.

2. The storybook of claim 1 wherein said animated pages are stored as computer readable code on a computer readable memory and said display comprises a computing device.

3. The storybook of claim 1 wherein said full body photographic image of a human being comprises an image of a child.

4. The storybook of claim 1 wherein said non-reader character comprises an anthropomorphized animal.

5. The storybook of claim 1 wherein said photographic image in said non-character image includes a trademark logo.

6. The storybook of claim 1 wherein said photographic image in said non-character image includes a branded image.

7. The storybook of claim 1 wherein said photographic image in said non-character image indicates a specific business entity.

8. The storybook of claim 7 wherein said business entity is a professional sports team.

9. The storybook of claim 1 wherein said photographic image in said non-character image is of a landmark.

10. The storybook of claim 9 wherein said landmark is in a city in which the story takes place.

11. An interactive electronic storybook comprising:
a computer, the computer including a display;
a computer memory, the memory having thereon:
computer readable instructions for displaying a series of animated pages for display on the display, the animated pages comprising:
text;
a full body photographic image of a human being;
a non-reader character being presented on at least some of the pages, the non-reader character being generated from a combination of photographs and drawn artwork; and
a background, the background including a non-character image which includes a photographic image corresponding to the background of the story;
computer readable instructions for animating at least a portion of the body of the photographic image of a human being; and
computer readable instructions for coordinating the animation of said at least a portion of the body of the photographic image to motion discussed in the text.

12. The storybook of claim 11 wherein said at least a portion of the body comprises the head, arms, or legs.

13. A method for providing for interactive reading, the method comprising
photographing a human reader to obtain a full body photographic image of the human reader;
providing a computer, the computer including a display;
providing a computer memory, the memory having thereon:
computer readable instructions for displaying a series of animated pages for display on the display, the animated pages comprising:
text;
the full body photographic image of the human reader;
a non-reader character being presented on at least some of the pages, the non-reader character being generated from a combination of photographs and drawn artwork; and
a background, the background including a non-character image which includes a photographic image corresponding to the background of the story;
computer readable instructions for animating at least a portion of the body of the photographic image of the human reader; and
computer readable instructions for coordinating the animation of said at least a portion of the body of the photographic image to motion discussed in the text;
the computer displaying each of said animated pages in order and simultaneously, providing audio of the text, highlighting each word in the text as the audio plays that word, and animating the photographic image of the human reader.

14. The method of claim 13 wherein said photographic image in said non-character image includes a trademark logo.

15. The method of claim 13 wherein said photographic image in said non-character image includes a branded image.

16. The method of claim 13 wherein said photographic image in said non-character image indicates a specific business entity.

17. The method of claim 16 wherein said business entity is a professional sports team.

18. The method of claim 13 wherein said photographic image in said non-character image is of a landmark.

19. The method of claim 18 wherein said landmark is in a city in which the story takes place.
